(19) United States
(12) Patent Application Publication
(10) Pub. No.: US 2005/0046367 A1
(43) Pub. Date: Mar. 3, 2005

(54) Circuit for providing power to multiple electrical devices

(75) Inventors: Bruno Wevers, Bloomfield, MI (US); Ronald G. Bedro, Plymouth, MI (US); Douglas C. Campbell, Northville, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/804,959

(22) Filed: Mar. 19, 2004

Related U.S. Application Data
(63) Continuation-in-part of application No. 10/651,749, filed on Aug. 29, 2003.

(51) Int. Cl. H02P 1/00; H02P 5/00

(52) U.S. Cl. 318/280

(57) ABSTRACT

The subject matter described herein relates to a system which comprises a first electrical device, a second electrical device, and a circuit configured to provide power to the first and second electrical devices. The circuit is configured to provide a first reversible voltage across the first electrical device using a first lead and a second lead. The circuit is also configured to use at least one of the first and second leads to provide a second voltage across the second electrical device. A polarity of the second voltage across the second electrical device remains constant when the polarity of the first voltage across the first electrical device is reversed.

### CROSS REFERENCE TO RELATED APPLICATIONS

This application is a continuation in part of U.S. patent application Ser. No. 10/651,749, entitled “Circuit for Providing Power to Multiple Electrical Devices,” filed on Aug. 29, 2003, pending, which is hereby expressly incorporated by reference herein in its entirety.

### BACKGROUND

The subject matter described herein relates generally to circuits for providing power to multiple electrical devices. In particular, the present invention relates to circuits for providing direct current (DC) power to multiple electrical devices.

Presently, there are a number of devices that use DC power. Many of these devices require DC power that has a constant polarity. In these devices, if the polarity of the power is reversed, the device may be severely damaged or destroyed. However, other DC devices are configured so that the polarity of the power may be reversible (e.g., reversible motors, etc.). Typically, because some of the electrical devices require constant polarity power and some require reversible polarity power, power for the constant polarity devices was obtained at a point in a circuit where the polarity of the power was not reversible (e.g., a position in the circuit before a switch that reversed the polarity of the DC power). This required separate power wires to be run to each of these devices, even in situations where the devices were located in close proximity to one another, thus increasing the cost and complexity of these devices.

Two electrical devices that may presently be powered using separate power wires are a seat motor and an integrated Hall-effect sensor. In some of these seat motors the number of wires may be reduced by using a single wire to transmit the signal from the Hall-effect sensor to the controller and to power the Hall-effect sensor. However, it may be desirable to reduce the number of wires even further.

Accordingly, there is a need for a simple and effective system for providing power to reversible polarity DC devices and constant polarity DC devices. Other features and advantages will be made apparent from the present description. The teachings disclosed extend to those embodiments that fall within the scope of the appended claims, regardless of whether they accomplish one or more of the aforementioned needs.

### DRAWINGS

FIG. 1 is a diagram of a system according to an exemplary embodiment.

FIG. 2 is another diagram of a system according to another exemplary embodiment.

FIG. 3 is a perspective view of a motor according to another exemplary embodiment.

FIG. 4 is a schematic drawing of a vehicle seat according to an exemplary embodiment.

FIG. 5 is another diagram of a system according to another exemplary embodiment.

FIG. 6 is another diagram of a system according to another exemplary embodiment.

### DETAILED DESCRIPTION

With reference to the accompanying Figs., the present disclosure relates to circuits for providing power to multiple direct current (DC) electrical devices (e.g., motors, sensors (e.g., encoders, hall effect sensors, potentiometers, optical sensors, etc. that measure speed, position, temperature, etc.), actuators, solenoids, latches, etc.) and systems which utilize such circuits. While the subject matter herein is presented in the context of the use of such circuit in conjunction with a motor and a sensor (e.g., position sensor, temperature sensor, etc.), such circuits may be utilized in alternative applications. Also, the features and/or configuration of one embodiment may be combined with other embodiments to form still additional embodiments, unless noted otherwise.

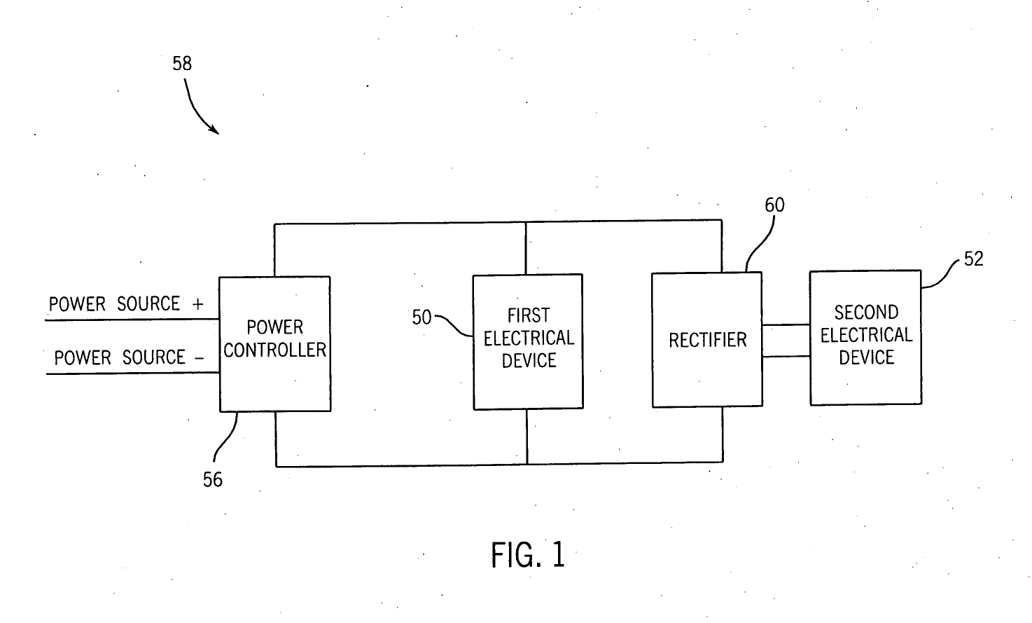

Referring to FIG. 1, a system 58 is shown that comprises a power controller 56, a first electrical device 50, a second electrical device 52, and a rectifier 60. System 58 is configured to provide DC power to first and second electrical devices 50 and 52.

Power controller 56 is configured to receive power from a power source and control the output of the power to first and second electrical devices 50 and 52. The power source is typically a DC power source such as a 12 volt battery (e.g., car battery), 24 volt battery, 6 volt battery, DC power supplies (e.g., power supply for a computer), etc. Power controller 56 is configured to control the polarity of the DC power provided to first electrical device 50 and rectifier 60. Accordingly, power controller 56 may comprise any of a number of suitable control devices (e.g., a three way rocker switch, an H-bridge, relays, transistors, etc.). In an exemplary embodiment, power controller comprises a microprocessor or other control circuit to control the polarity of the power provided to first electrical device 50. In another exemplary embodiment, power controller may be configured to change the polarity of the DC power provided to first electrical device 50 in response to user input. The user may provide input by pressing a button (e.g., a button to control a motorized automotive device, etc.), changing the position of a switch, etc. In an exemplary embodiment, the user input is received by a microprocessor that is configured to control the polarity of the DC power provided to motor 50.

In general, first electrical device 50 is configured to be any DC electrical device that is capable of receiving reversible polarity power. Examples of such devices include reversible DC motors, actuators, solenoids, etc. Although system 58 is shown with only first electrical device 50 receiving reversible polarity DC power, in other embodiments, multiple electrical devices may be configured to receive reversible polarity DC power (e.g., two reversible DC motors in parallel, etc.).

Second electrical device 52 may be any of a number of electrical devices configured to receive constant polarity DC power. Examples of such devices include sensors such as those mentioned above, buzzer, LED, etc. Also, system 58 may be configured to include multiple electrical devices configured to receive constant polarity DC power.

In an exemplary embodiment, the power used to power first and second electrical devices 50 and 52 is approximately equal voltage. In this embodiment, there is no need to alter the power provided to first electrical device 50 to provide power to second electrical device 52.

Rectifier 60 is generally configured to receive the reversible polarity DC power provided to first electrical device 50 and output constant polarity DC power to second electrical device 52. Thus the polarity of the power provided to second electrical device 52 is the same regardless of the polarity of the power provided to first electrical device 50. Accordingly, rectifier 60 may be any of a number of suitable circuit elements that function to convert reversible polarity DC power to constant polarity DC power (e.g., diodes, thyristors, SCRs, portions of a printed circuit board, etc.).

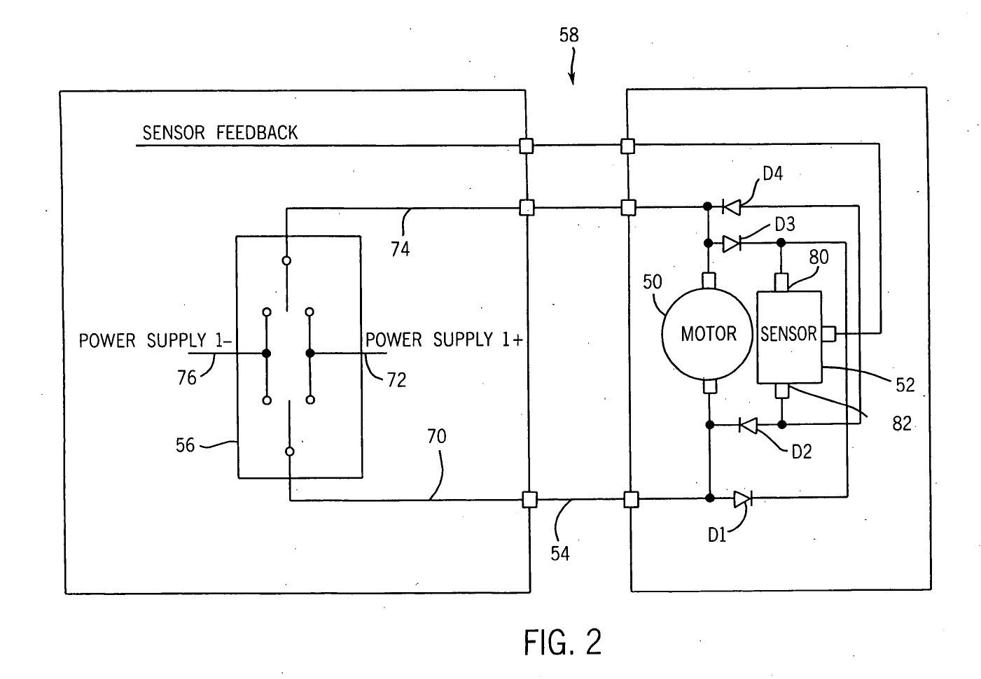

Referring to FIG. 2, an exemplary embodiment of system 58 is shown. In this embodiment, system 58 comprises a motor 50, a sensor 52, a circuit 54, and power controller 56. In an exemplary embodiment, system 58 is configured to use motor 50 to adjust the position of a mechanical device (e.g., vehicle devices such as a vehicle seat or its components, a mirror, one or more foot pedals, reversible controlled fan, HVAC, motorized throttle, steering column, etc.) and use sensor 52 to measure the position of the mechanical device.

As shown in FIG. 2, power controller 56 is an H-bridge. The polarity of DC power provided to motor 50 may be controlled using the H-bridge. For example, when a first lead 70 is in contact with voltage supply 72 and a second lead 74 is in contact with ground 76, then a potential difference exists between first lead 70 and second lead 74 across motor 50. The potential difference causes DC current to flow from first lead 70, through motor 50, to second lead 74, which moves motor 50 in a first direction. However, when second lead 74 is in contact with voltage supply 72 and first lead 70 is in contact with ground 76, then a potential difference exists between second lead 74 and first lead 70 across motor 50. DC current flows from second lead 74, through motor 50, to first lead 70, which moves motor 50 in a second direction. In this manner, the direction of rotation of an armature in the motor 50 is controlled. As mentioned previously, a number of suitable controllers may be substituted for the H-bridge. In an exemplary embodiment, power controller 56 is configured to reverse the polarity of the power provided to motor 50 in response to input from a user as described above.

In an exemplary embodiment, motor 50 is a conventional DC motor that includes an armature, a stator, windings, etc. In another exemplary embodiment, motor 50 may be configured to be of the size and type that is used in conjunction with moving vehicle devices.

In an exemplary embodiment, sensor 52 is a position sensor. For example, sensor 52 may be a Hall Effect sensor, a potentiometer, etc. In other embodiments, sensor 52 may be any of a number of low current sensors (e.g., position sensors, temperature, sensors, speed sensor, encoder, buzzer, LED, etc.).

As shown in FIG. 2, system 58 includes four diodes D1, D2, D3, and D4, which are configured to provide constant polarity power to sensor 52. For example, when the polarity of the voltage is configured so that current flows from first lead 70 to second lead 74 through motor 50, then current flows through diode D1, into a high side 80 of sensor 52, and out a low side 82 of sensor 52. The current then continues to second lead 74 by way of diode D4. In this configuration, diode D2 prevents current from flowing to low side 82 of sensor 52 and damaging sensor 52. When the polarity of the voltage is configured so that current flows from second lead 74 to first lead 70 through motor 50, then current flows through diode D3 and into high side 80 of sensor 52. The current flows out of low side 82 and through diode D2 to first lead 70. In this configuration, diode D4 prevents current from flowing to low side 82 and damaging sensor 52. Thus, diodes D1-D4 convert the reversible polarity voltage provided to motor 50 to a constant polarity voltage provided to sensor 52.

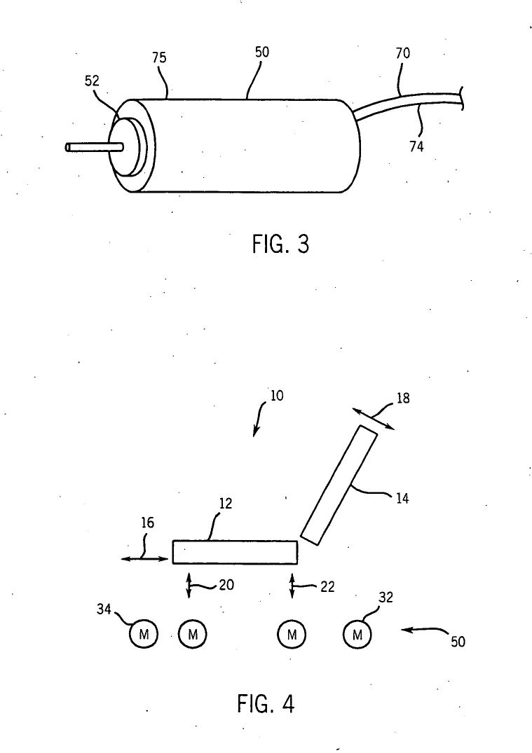

In an exemplary embodiment, as shown in FIG. 3, motor 50 and sensor 52 are integrally coupled together, for example, in a single package 75. Sensor 52 and motor 50 may be integrally coupled together so that removal of sensor 52 requires substantial disassembly of motor 50 (e.g., removal of the housing of motor 50) or may be coupled together so that sensor 52 is external to motor 50. Single package 75 can further include diodes D1-D4, and/or any other suitable circuitry or hardware. In this embodiment, motor 50 comprises first lead 70 and second lead 74, which are configured to be coupled to a power source. The two leads provide power to both motor 50 and sensor 52 and are configured to be coupled to power controller 56. Thus, motor 50 including sensor 52 and leads 70-74 may be provided as a stand-alone product. In an exemplary embodiment, sensor 52 included with motor 50 is a Hall Effect sensor configured to measure the number of turns and/or speed of the armature in motor 50.

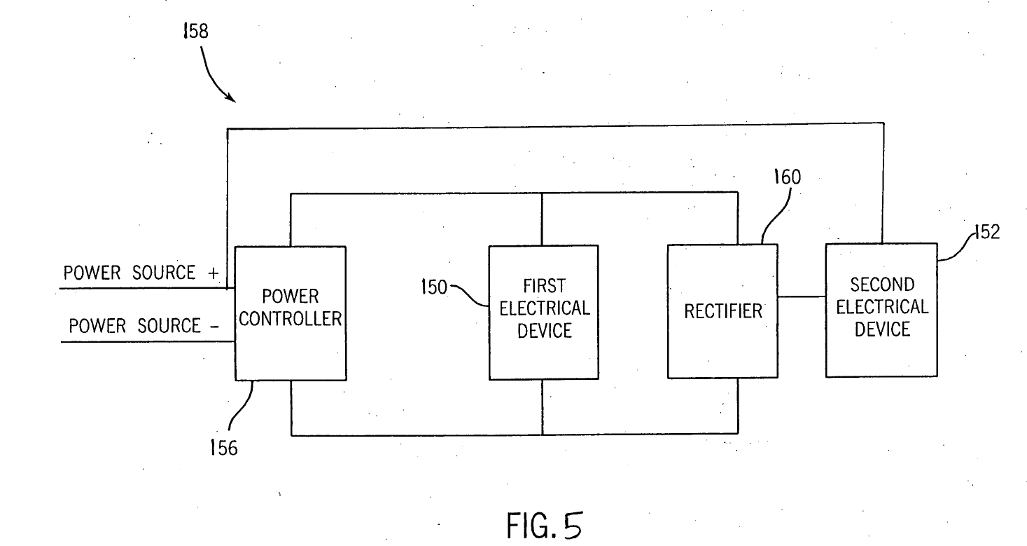

In an exemplary embodiment, shown in FIG. 4, system 58 is configured to be used in conjunction with a vehicle system, which, in this embodiment, is in the form of vehicle seat 10. Vehicle seat 10 comprises a seat base 12 and a seat back 14. Seat base 12 and seat back 14 are coupled to a track, such as an adjuster or other mounting member. Vehicle seat 10 comprises one or more motors 50 that may be configured to adjust the position of seat base 12 and/or seat back 14. In an exemplary embodiment, seat base 12 includes a seat base motor 34 configured to move the seat base forward and backward, as indicated by arrow 16. Seat back 14 includes a seat back motor 32 configured to adjust an angle of inclination, as indicated by arrow 18, of seat back 14. Vehicle seat 10 can further include motors 50 configured to adjust the vertical height of seat base 12 (arrow 20) and the back of seat base 12 (arrow 22). Vehicle seat 10 may also include other electrical seat devices such as a seat heater (not shown) and/or a seat massager (not shown).

In an exemplary embodiment, system 58 may be used to implement a variety of desirable features. For example, system 58 may be used in conjunction with a memory feature. The memory feature allows the user to manually move vehicle seat 10 to a desirable position and store that position in memory. If vehicle seat 10 is moved from that position it may be restored to the desired position by pressing a button. When the button is pressed power controller 56 controls the actuation of one or more of motors 50, which, in turn, move vehicle seat 10 to the desired position. As vehicle seat 10 moves, sensor 52 is configured to measure its position and output the position to a microprocessor in power controller 56. By inputting the measured position into a microprocessor controller or other control circuit, a feedback control loop can be used to move vehicle seat 10 back to the stored position. Of course, other configurations may also be used. For example, in another embodiment, vehicle seat 10 may be configured to include multiple systems 58 configured to control the position of multiple seat devices. In another embodiment, vehicle seat 10 may be configured to include a single system 58 that is configured to control the position of multiple components of vehicle seat 10.

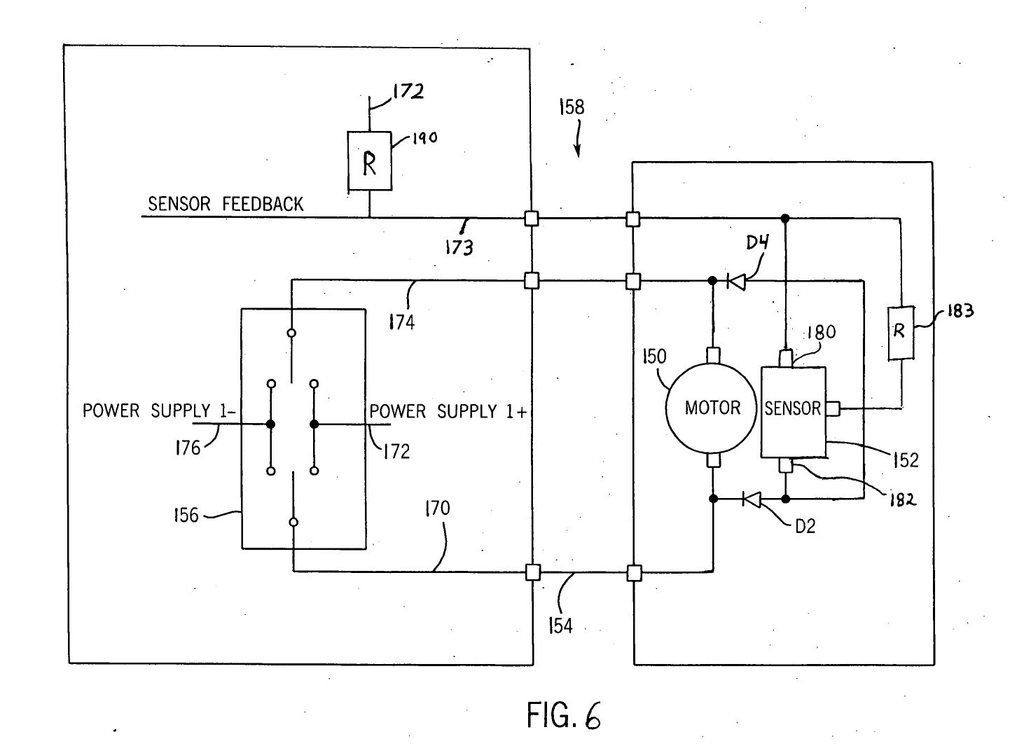

Referring to FIGS. 5 and 6, another embodiment of a system 158 is shown that comprises a power controller 156, a first electrical device 150, a second electrical device 152, and a rectifier 160. System 158 is configured to provide DC power to first and second electrical devices 150 and 152 in a manner similar to that shown in relation to system 58 in FIG. 1. Also, system 158 may be used and/or configured in the various ways described in connection with system 58.

In the embodiment shown in FIG. 5, rectifier 160 is generally configured to rectify the power on the high side 180 or low side 182 (FIG. 6) of second electrical device 152. Thus, second electrical device 152 may be configured to use first lead 170 or second lead 174 to couple second electrical device 152 to voltage supply 172 or ground 176. In the embodiment shown in FIG. 6, high side 180 of second electrical device 152 is coupled to voltage supply 172 via resistor 190 and low side 182 is provided to ground 176 by first lead 170 or second lead 174 depending on the polarity of the voltage across the first electrical device (e.g., the high side and low side of first electrical device 150 may be provided using either first lead 170 or second lead 174 depending on the polarity of the voltage across first electrical device 150). Accordingly, rectifier 60 may be any of a number of suitable circuit elements that allow at least one of first lead 170 or second lead 174, which are reversible in polarity, to be used to provide a ground to second electrical device 152.

Referring to FIG. 6, an exemplary embodiment of system 158 is shown. In this embodiment, system 158 comprises a motor 150, a sensor 152, a circuit 154, and power controller 156. In an exemplary embodiment, system 158 is configured to use motor 150 to adjust the position of a mechanical device (e.g., vehicle devices such as a vehicle seat or its components, a mirror, one or more foot pedals, reversible controlled fan, HVAC, motorized throttle, steering column, etc.) and use sensor 152 to measure the position of the mechanical device. In general, system 158 is similar to that of system 58 shown in FIG. 2. The variety of configurations and/or features described in connection with FIG. 2 may be used in conjunction with system 158.

As shown in FIG. 6, power controller 156 is an H-bridge. The polarity of DC power provided to motor 150 may be controlled using the H-bridge. For example, when a first lead 170 is in contact with voltage supply 172 and a second lead 174 is in contact with ground 176, then a potential difference exists between first lead 170 and second lead 174 across motor 150. In this example, first lead 170 is the high side and second lead 174 is the low side. The potential difference causes DC current to flow from first lead 170, through motor 150, to second lead 174, which moves motor 150 in a first direction. However, when second lead 174 is in contact with voltage supply 172 and first lead 170 is in contact with ground 176, then a potential difference exists between second lead 174 and first lead 170 across motor 150. In this example, first lead 170 is the low side and second lead 174 is the high side. DC current flows from second lead 174, through motor 150, to first lead 170, which moves motor 150 in a second direction. In this manner, the direction of rotation of an armature in the motor 150 is controlled. As mentioned previously, a number of suitable controllers may be substituted for the H-bridge. In an exemplary embodiment, power controller 156 is configured to reverse the polarity of the power provided to motor 150 in response to input from a user as described above.

As shown in FIG. 6, a third lead 173 is provided which is coupled to voltage supply 172 via resistor 190 and functions as the high side of sensor 152. Also, third lead 173 is used to provide or transmit control signals from sensor 152 to a controller (e.g., microprocessor, etc.). In this configuration, the lead that would otherwise be needed to couple sensor 152 to ground 176 is not needed, thus providing a cost savings in producing system 158. Also, this allows the power to motor 150 to be disconnected while still providing power to sensor 152. In one embodiment, this is done by disconnecting the high side of motor 150 without disconnecting the low side so that the low side may still be used by sensor 152. This may be desirable for those situations where motor 150 continues to move after the power has been switched off. In these situations, sensor 152 is still provided with power and, thus, can continue to sense the additional movement even though motor 150 has been switched off. Of course, other embodiments are also contemplated as would be recognized by those of ordinary skill in the art.

Third lead 173 coupled to sensor 152 may be used to provide control signals from sensor 152 to a controller which can, in turn, provide control signals to control the speed of motor 150, the position of a device coupled to motor 150, etc., based on the control signals received from sensor 152. In one embodiment, control signals are provided using third lead 173 by varying the high side voltage using resistor 183.

In the embodiment shown in FIG. 6, system 158 includes two diodes D2 and D4, which are configured to allow sensor 152 to use first lead 170 or second lead 174 to in order to connect to ground 176. For example, when the polarity of the voltage across motor 150 is configured so that current flows from first lead 170 to second lead 174 then the current flows out of sensor 152 and through diode D4, through second lead 174, and into ground 176. When the polarity of the voltage across motor 150 is configured so that current flows from second lead 174 to first lead 170 then current flows out of sensor 152 through diode D2, through first lead 170, and into ground 176. Thus, diodes D2 and D4 are used to provide a pathway to ground 176 using first and/or second leads 170, 174.

In an exemplary embodiment, sensor 152 is a position sensor. For example, sensor 152 may be a Hall Effect sensor, a potentiometer, etc. In other embodiments, sensor 152 may be any of a number of low current sensors (e.g., position sensors, temperature, sensors, speed sensor, encoder, buzzer, LED, etc.).

In another embodiment, one or more diodes D2, D4, and resistors 183 can be provided on a printed circuit board (PCB), which provides power to the motor. Accordingly, one or more of these circuit elements (and the electrical leads associated therewith) can be integrated into an existing PCB without adding size or substantially changing the manufacturing process that provides a package such as that shown in FIG. 3.

The construction and arrangement of the elements of the system as shown in the embodiments is illustrative only. Although only a few embodiments of the present invention have been described in detail in this disclosure, those of ordinary skill who review this disclosure will readily appreciate that many modifications are possible without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the embodiments without departing from the scope of the present invention as expressed in the appended claims.

1. A system comprising:
a first electrical device;
a second electrical device; and
a circuit configured to provide power to the first and second electrical devices;
wherein the circuit is configured to provide a first reversible voltage across the first electrical device using a first lead and a second lead, the circuit also being configured to use one or both of the first or second leads to provide a second voltage across the second electrical device;
wherein a polarity of the second voltage across the second electrical device remains constant when the polarity of the first voltage across the first electrical device is reversed.

2. The system of claim 1 wherein the first electrical device is a reversible motor.

3. The system of claim 1 wherein the second electrical device is a position sensor.

4. The system of claim 1 wherein the first electrical device is a reversible motor and the second electrical device is a position sensor that is coupled to the motor.

5. The system of claim 4 wherein the position sensor is integrally coupled to the motor in a single package.

6. The system of claim 1 wherein the second electrical device comprises a third lead which is configured to provide the second voltage across the second electrical device and to transmit control signals.

7. The system of claim 1 wherein a plurality of diodes are used to maintain the polarity of the second voltage constant when the polarity of the first voltage is reversed.

8. The system of claim 1 wherein the polarity of the first voltage is reversible in response to user input.

9. The system of claim 1 wherein the first electrical device is a vehicle seat motor.

10. The system of claim 1 wherein the second electrical device uses the first lead or second lead as ground depending on the polarity of the first voltage.

11. A system comprising:
a first electrical device coupled to a voltage supply on a high side and to a ground on a low side, the high side and the low side being reversible; and
a second electrical device which is powered using constant polarity voltage and which uses the high side and/or the low side to provide the constant polarity voltage.

12. The system of claim 11 wherein the first electrical device is a reversible motor.

13. The system of claim 11 wherein the second electrical device is a position sensor.

14. The system of claim 11 wherein the second electrical device is coupled to the voltage supply on a high side which is also used to transmit control signals.

15. The system of claim 11 wherein a plurality of diodes are used to provide the constant polarity voltage using the high side and/or the low side.

16. The system of claim 11 wherein the reversible polarity voltage is reversed in response to user input.

17. The system of claim 11 wherein the second electrical device is coupled to the ground using the low side and is coupled to the voltage supply on a high side which is also used to transmit control signals to a controller.

18. The system of claim 11 wherein the second electrical device uses the high side or the low side as ground depending on the polarity of the first electrical device.

19. A direct current motor package comprising:
a sensor coupled to a motor;
a first lead; and
a second lead;
wherein the first lead and the second lead are coupled to a power controller, the power controller being used to reverse the polarity of the leads to provide reversible polarity power to the motor; and
wherein the first lead and/or the second lead is used to provide constant polarity power to the sensor.

20. The motor package of claim 19 wherein the motor comprises a housing, the sensor being positioned inside the housing.

21. The motor package of claim 19 wherein the sensor is a Hall Effect sensor, a potentiometer, or an optical sensor.

22. The motor package of claim 19 wherein the motor is configured to be used to adjust the position of an automotive device.

23. The motor package of claim 19 wherein the motor comprises a plurality of diodes that are configured to provide the constant polarity power to the sensor using the first lead and/or the second lead.

24. The motor package of claim 19 further comprising a third lead coupled to the sensor, the third lead being configured to provide the constant polarity power to the sensor and to transmit control signals.

25. The motor package of claim 19 wherein the sensor uses one of the first lead or second lead that is coupled to a ground and a third lead that is coupled to a voltage supply to provide the constant polarity power.

26. The motor package of claim 25 wherein the third lead is also used to transmit control signals.

27. The motor package of claim 19 wherein the sensor uses the first lead or second lead as ground depending on the polarity of motor.

28. A direct current motor package comprising:
a position sensor coupled to a motor;
wherein the motor is coupled to a voltage supply on a high side and is coupled to a ground on a low side, the high side and the low side being reversible to reverse a polarity of a voltage across the motor; and
wherein the position sensor is powered using constant polarity voltage and uses the high side and/or the low side to provide the constant polarity voltage.

29. The motor package of claim 28 wherein the position sensor is a Hall Effect sensor, a potentiometer, or an optical sensor.

30. The motor package of claim 28 wherein a power controller is used to control the polarity of the voltage across the motor.

31. The motor package of claim 28 wherein the motor comprises a housing, the position sensor being positioned inside the housing.

32. The motor package of claim 28 wherein a plurality of diodes are used to provide the constant polarity voltage using the high side and/or low side.

33. The motor package of claim 28 wherein the position sensor is coupled to the voltage supply on a high side which also is used to transmit control signals.

34. The motor package of claim 28 wherein the position sensor uses the high side or the low side as ground depending on the polarity of the motor.

35. A vehicle system comprising:
a direct current motor configured to adjust a position of a vehicle device;
a sensor configured to measure the position of the vehicle device; and
wherein the motor is coupled to a voltage supply on a high side and is coupled to a ground on a low side, the high side and the low side being reversible to reverse a polarity of a voltage across the motor; and
wherein the sensor is powered using constant polarity voltage and uses the high side and/or the low side to provide the constant polarity voltage.

36. The vehicle system of claim 35 further comprising:
a seat back; and
a seat base;
wherein the motor is configured to adjust the position of the seat back and/or seat base.

37. The vehicle system of claim 35 wherein the sensor is selected from a group consisting of a Hall Effect sensor and a potentiometer.

38. The vehicle system of claim 35 wherein the circuit further comprises a power controller configured to control the polarity of the voltage across the motor.

39. The vehicle system of claim 35 wherein the motor and the sensor are coupled together in an integral package.

40. The vehicle system of claim 35 wherein the sensor is coupled to the voltage supply on a high side which also is used to transmit control signals.

41. The vehicle system of claim 35 wherein a plurality of diodes are used to provide the constant polarity voltage using the high side and/or the low side.

42. The vehicle system of claim 35 wherein the sensor uses the high side or the low side as ground depending on the polarity of the motor.
